(19) United States
(12) Patent Application Publication
(10) Pub. No.: US 2015/0298584 A1
(43) Pub. Date: Oct. 22, 2015

(54) SEAT FITTING FOR A MOTOR VEHICLE SEAT

(71) Applicant: KEIPER GMBH & CO. KG, Kaiserslautern (DE)

(72) Inventor: Rolf SCHÜLER, Heiligenhaus (DE)

(73) Assignee: Johnson Controls Components GmbH & Co KG, Kaiserslautern (DE)

(21) Appl. No.: 14/650,097

(22) PCT Filed: Dec. 4, 2013
(86) PCT No.: PCT/EP2013/075479

§ 371 Date: Jun. 5, 2015

(30) Foreign Application Priority Data
Dec. 7, 2012 (DE) 10 2012 111 941.4

(51) Int. Cl. B60N 2/225

(52) U.S. Cl. CPC B60N 2/2252; B60N 2/2254

(57) ABSTRACT

A motor vehicle seat fitting has a ring gear fitting part with internal toothing and a gear wheel fitting part which outer toothing, an eccentric mounted rotatably in a bore, which runs axially with respect to the gear wheel, for the rolling adjustment of the gear wheel in relation to the ring gear, and a drive shaft which drives the eccentric and extends axially with respect to the ring gear. On the gear wheel or ring gear, a blocking element is arranged in a section running between the toothing and the bore. On the other of the gear wheel and ring gear stop cam carrier is arranged in a manner secure against rotation. The stop cam carrier has two stop cams which interact with the blocking element to limit a maximum adjustability of the two fitting parts with respect to each other in an opposed direction of movement.

### CROSS REFERENCE TO RELATED APPLICATIONS

This application is a United States National Phase application of International Application PCT/EP2013/075479 filed Dec. 4, 2013 and claims the benefit of priority under 35 U.S.C. §119 of German Patent Application 10 2012 111 941.4 filed Dec. 7, 2012, the entire contents of which are incorporated herein by reference.

### FIELD OF THE INVENTION

The present invention relates to a seat fitting for a motor vehicle seat, comprising a first fitting part with a ring gear having an inner toothing, a second fitting part with a gearwheel, which has an outer toothing and is meshed with the ring gear, an eccentric, which is mounted rotatably in a bore, running axially with respect to the gearwheel, in the second fitting part, and which is intended for the rolling adjustment of the gearwheel in relation to the ring gear, and a driveshaft, which drives the eccentric and extends axially with respect to the ring gear.

### BACKGROUND OF THE INVENTION

Seat fittings of the type mentioned in the introduction, as are known for example from DE 10 2008 036 647, are used in motor vehicle seats in order to adjust a backrest adjustable in relation to a seat part, wherein a fitting part is connected to the seat part and another fitting part is connected to the backrest. In seat fittings of this type a rotation of the driveshaft causes a rotation of the eccentric, whereby a wobbling rolling of the gearwheel in relation to the ring gear in the manner of a wobble gear is achieved. The fitting parts pivot relative to one another as a result, in accordance with the difference in the number of teeth.

Seat fittings of the type mentioned in the introduction make it possible to provide a continuous adjustment, wherein the installation space necessary for the seat fitting is extremely small. In addition, the eccentricity of the eccentric is suitable for producing a self-locking, which secures the seat fitting reliably in each set position.

The pivot range of the backrest in relation to the seat part predefined by the seat fittings is usually achieved by stops arranged externally on the fitting parts. Stops of this type and the precise positioning thereof are necessary in order to prevent a jamming at the ends of the adjustment range, wherein this is necessary in particular in the case of electrically driven seat fittings. The stops, which are usually arranged externally on the seat fittings, have the disadvantage that, for these, a movement space in the pivot range of the seat fitting has to be kept free. The embodiment of the end stops additionally leads to increased manufacturing costs and ultimately poses a pinching risk, both for cushion parts and for the user.

### SUMMARY OF THE INVENTION

An object of the invention is to provide a seat fitting which can be produced economically and at least predominantly in mass production, which has a particularly compact design, and of which the pivot range is reliably fixed, wherein the maximum pivot range of the seat fitting can be adapted easily to any number of vehicle seat types during installation.

The seat fitting for a motor vehicle seat according to the invention comprises a first fitting part with a ring gear having an inner toothing, a second fitting part with a gearwheel, which has an outer toothing and is meshed with the ring gear, an eccentric, which is mounted rotatably in a bore, running axially with respect to the gearwheel, in the second fitting part, and which is intended for the rolling adjustment of the gearwheel in relation to the ring gear, and a driveshaft, which drives the eccentric and extends axially with respect to the ring gear. On one of the gearwheel and ring gear, preferably on the ring gear, a blocking element is arranged in a section running between the toothing and the bore, and on the other of the gearwheel and ring gear, preferably the gearwheel, a stop cam carrier can be arranged in a manner secure against rotation, the stop cam carrier having two stop cams, which cooperate with the blocking element in such a way that the maximum adjustability of the two fitting parts with respect to one another in an opposed direction of movement is limited by one stop cam in each case.

An adjustment of the seat fitting according to the invention, whereby a displacement of the first fitting part with respect to the second fitting part is achieved, is implemented by a rotation of the driveshaft extending axially relative to the ring gear. This drives the eccentric, which causes a rolling adjustment of the gearwheel in relation to the ring gear, as a result of which the first fitting part is pivoted in relation to the second fitting part. In this case, as a result of the system, the gearwheel is arranged within the ring gear and during the adjustment performs a wobble movement caused by the eccentric.

The embodiment according to the invention of the adjustment range of the gearwheel in relation to the ring gear by means of two stop cams arranged on the stop cam carrier and cooperating with the blocking element enables a particularly simple and economical production of all component parts of the seat fitting in mass production. The seat fitting can be adapted to the respective vehicle series via the stop cam carrier. The use of this stop cam carrier adapted to the respective vehicle type makes it possible to quickly and easily make a limitation, adapted to the respective vehicle seat, of the maximum adjustment range during the installation. In addition, the embodiment according to the invention has the advantage that, on account of the arrangement within the seat fitting of stop cams and blocking element, the risk of a pinching of foreign parts or of the user can be completely ruled out. The seat fitting according to the invention also has a smaller installation space compared to known seat fittings with external stops.

In principle, any component that can be arranged on a vehicle seat, in particular a motor vehicle seat, and in doing so interconnects two component parts movably, wherein this movement preferably comprises a pivot movement and particularly preferably is limited substantially to a pivot movement about an axis, is understood in principle to be a seat fitting. The seat fitting according to the invention here has a first fitting part, which is pivotable with respect to the second fitting part. Here, one fitting part can be connected to a seat part and the other fitting part can be connected to a backrest of the motor vehicle seat.

In principle, both the gearwheel and the ring gear can be formed from any material, for example metal, a plastic, a composite material or a ceramic, and may have any form. In addition, these component parts may each be an individual component part or an assembly formed from a number of component parts. The gearwheel, compared with the ring gear and at least in the toothed region, preferably on the whole has a smaller outer diameter radially with respect to an axis of rotation of the gearwheel, such that the gearwheel can be arranged particularly preferably completely within the ring gear in the radial direction, wherein the gearwheel can still protrude out from the ring gear in portions in the axial direction.

In this case, the gearwheel in at least one region has an outer toothing, which preferably runs substantially circularly in an outer region of the gearwheel and has a radially constant distance from an axis of rotation of the gearwheel, which preferably runs through the centerpoint of the bore in the gearwheel. Here, the outer toothing is formed in such a way that it can cooperate with the inner toothing of the ring gear, in particular, can perform a wobbling rolling movement within the inner toothing.

The ring gear has an inner toothing, which preferably runs substantially circularly in an inner region of the ring gear and has a radially constant distance from an axis of rotation of the ring gear, which preferably runs through the centerpoint of the bore in the ring gear.

The toothing of the gearwheel and/or of the ring gear here may have any form, for example a straight, inclined or oppositely inclined toothing. The individual teeth of the toothing spanning a circular circumference of the gearwheel and/or of the ring gear preferably have a substantially rectangular form, wherein the base of each of the indentations between two teeth is particularly preferably rounded.

The second fitting part according to the invention has a bore running axially relative to the gearwheel. A bore is not only understood to be a circular recess in a component part, formed by material removal by means of drilling. Rather, a bore may be any recess passing through a component part, which recess is of any form and can be produced by material removal on the component part and also is provided from the start during the production of the component part. Here, the bore can be formed for example during the casting or forming of the component part, by milling, drilling, sawing, punching or by another production or forming method. Here, the purpose of the bores is to receive a driving wheel, a securing ring, a spindle, an eccentric, a driveshaft or another component part.

In principle, any component part that is suitable for transmitting a rotational movement to the seat fitting, in particular to an eccentric of the seat fitting, is understood to be a driveshaft. Here, the driveshaft can be formed arbitrarily and can consist of any material. The driveshaft may also be formed from an assembly of a number of component parts. Here, the driveshaft does not have to be formed from a separate component part, but can be integrated in other component parts with further functions, for example as part of a gearwheel, a driving wheel or a pinion.

The seat fitting according to the invention in the installed state has a peripheral cavity, within which a blocking element is arranged, which interrupts the cavity in portions or reduces a cross-sectional area of the cavity at least in one region. Here, the cavity is formed in the installed state between the gearwheel and the ring gear and runs coaxially with respect to the fitting axis. The stop cam carrier is additionally arranged within this cavity and preferably at least in portions bears directly against the ring gear or against the gearwheel. In order to limit the pivot range of the seat fitting, i.e. to fix the adjustment range of the first fitting part relative to the second fitting part, the blocking element protruding in the direction of the stop cams arranged on the stop cam carrier is arranged within the cavity, such that the side faces of the blocking element serve as a stop for each of the two stop cams.

The embodiment of the blocking element is freely selectable in principle. Here, it may be a separate component part arranged on the ring gear or on the gearwheel. In addition, it is conceivable that the blocking element is formed in a number of pieces. However, the blocking element is preferably formed in one piece with the gearwheel or the ring gear.

The blocking element preferably has two side faces, which are formed in such a way that they can come into contact over the greatest area possible with part of the stop cams. The blocking element is particularly preferably located on the gearwheel or the ring gear radially with respect to the axis of rotation of the component part within the toothing of the component part.

In accordance with the invention the stop cam carrier is arranged in a manner that is secure against rotation on the ring gear or on the gearwheel and is positioned in the cavity between the ring gear and the gearwheel. In this case, in the installed state, the stop cams protrude from the gearwheel or the ring gear connected to the stop cam carrier, such that the stop cams arranged on the stop cam carrier can come into contact with the blocking element, preferably via the side faces of these components.

The use of a separate stop cam carrier here enables a production of the other component parts of the seat fitting in mass production and a subsequent adaptation of the maximum pivot range to the respective motor vehicle type or vehicle seat type during the installation.

In this case, the stop cam carrier can be arranged arbitrarily in principle. It is thus possible to weld, to adhesively bond or to otherwise integrally bond the stop cam carrier to the gearwheel or ring gear. In addition or in a supplementary manner, it is possible to embody the stop cam carrier in such a way that it substantially completely fills out the available installation space, or additional support points may be provided, which enable a form-fitting and/or force-locked mounting.

In accordance with an advantageous embodiment of the invention, however, the stop cam carrier is designed in such a way and the ring gear or the gearwheel has a corresponding embodiment, that the stop cam carrier in the installed state is secure against rotation in relation to the gearwheel or ring gear in a form-fitting and/or force-locked manner, whereby on the one hand an especially compact design of the seat fitting is enabled and on the other hand the seat fitting can be individualized by using a corresponding stop cam carrier during the assembly or the installation in an especially simple and particularly time-efficient manner.

In accordance with this embodiment of the invention the stop cam carrier for example may have radially projecting protrusions, which engage with corresponding recesses on the ring gear or the gearwheel. The stop cam carrier and the ring gear or gearwheel may also have a rotation-blocking contour. This embodiment of the invention allows a simple and variable installation of the seat fitting. An additional positional securing can be achieved here where appropriate by a further component part. By way of example, a spacer ring with a clip device can be used to lock the stop cam carrier in its position on the gearwheel or ring gear.

In principle the stop cams can be formed from any material and may have any form. The stop cams are preferably formed from the same material as the stop cam carrier, and the stop cam carrier and the stop cams are particularly preferably formed in one piece. Here, the stop cams, in particular in respect of the arrangement of both stop cams, are arranged along the periphery of the stop cam carrier in such a way that a side face of each of the stop cams cooperates with the blocking element at a predefined adjustment angle of the seat fitting on the motor vehicle seat and thus limits the maximum pivot range efficiently and in a particularly simple manner. Here, the arrangement of the stop cams on the stop cam carrier can be adapted for each vehicle seat type to the respective seat geometry, and the seat fitting can thus be adapted to the respective vehicle seat type by use of a suitable stop cam carrier in a particularly simple manner.

In accordance with an advantageous development of the invention the blocking element has a profile coaxial with the associated bore and/or the stop cam has a profile coaxial with the centerpoint axis of the stop cam carrier, whereby an embodiment of the blocking element of any length and/or a stop cam in the peripheral direction of the ring gear or of the stop cam carrier is enabled, without hindering an adjustment of the ring gear in relation to the gearwheel and also the stop cam carrier arranged fixedly thereon.

In accordance with a particularly advantageous development of the invention, the gearwheel and/or the ring gear are formed in such a way that the stop cam carrier can be arranged between the two components with stop cams of any length in the peripheral direction and/or with stop cams arranged in any positions along the periphery, whereby a possibility of free, unrestricted individualization of the seat fitting is ensured by the form of the gearwheel and of the ring gear. For this purpose, the ring gear and/or the gearwheel particularly preferably have a substantially rotationally symmetrical embodiment, in particular rotationally symmetrical with respect to the axis of rotation of the respective component part during operation of the seat fitting.

In accordance with a further advantageous development of the invention, in the installed state the stop cams are arranged on the stop cam carrier in such a way that they protrude substantially radially in the peripheral direction of the stop cam carrier on one side from the surface thereof and are preferably arranged in the region of the outer periphery of the stop cam carrier, whereby the stop cam carrier can be produced in a particularly material-efficient and economical manner. The embodiment of the stop cam carrier with stop cams protruding on one side from the surface thereof also allows the stop cam carrier to cooperate on a side having the stop cams with the blocking element, whereas the other side can be arranged close to the surface of the gearwheel or the ring gear, whereby a particularly compact designed is enabled.

In accordance with a particularly advantageous embodiment of the invention the side face of each of the stop cams oriented in the peripheral direction and cooperating with the blocking element has a form adapted to the respective side face of the blocking element. In accordance with this embodiment of the invention the side faces of the blocking element and of the stop cams coming into contact with one another at the end of the pivot range are coordinated with one another in such a way that the faces assigned to one another contact one another in a planar manner. As a result of this embodiment of the invention a particularly reliable end stop is provided, wherein in particular a jamming of the side face is prevented in a particularly advantageous manner.

As a result of the system and on account of the rolling adjustment produced by the eccentric, each of the stop cams describes a cycloid path within an inner region of the ring gear in relation to the blocking element when the ring gear is adjusted relative to the gearwheel. During the adjustment, the movement component directed in the radial direction thus varies compared with the movement component of a stop cam directed in the peripheral direction.

In accordance with a particularly advantageous embodiment of the invention the stop cams and the blocking element are positioned in such a way that each of the stop cams moved relative to the blocking element over a cycloid path during an adjustment comes into contact with the side face of the blocking element in the region of the path in which the movement component of the path directed in the peripheral direction is greater than the movement component directed in the radial direction.

In accordance with this embodiment of the invention the blocking element and the stop cams are coordinated with one another in such a way that they come into contact with one another when the movement component pointing in the peripheral direction outweighs the movement component directed in the radial direction. A jamming of stop cams and blocking element can thus be prevented in a particularly reliable manner. The risk of a jamming could then exist when one of the stop cams and the blocking element come into contact with one another when the movement component of the stop cam in the radial direction significantly exceeds that in the peripheral direction.

In accordance with an advantageous development of the invention the blocking element is arranged on the ring gear. Here, the blocking element is preferably formed in one piece with the ring gear, whereby it can be produced in a particularly simple and economical manner and at the same time a detachment of the blocking element from the ring gear is particularly effectively prevented.

In accordance with a particularly preferred development of the invention the length of the blocking element in the peripheral direction of the ring gear is less than 25%, more preferably less than 10% of the periphery of the ring gear, whereby the total weight of the seat fitting and also the production costs advantageously can be kept low.

In accordance with a particularly advantageous embodiment of the invention the eccentric has a driver and also two wedge segments. The embodiment of the eccentric for driving the gearwheel in relation to the ring gear can be arbitrary in principle. In accordance with a particularly advantageous embodiment of the invention, however, the eccentric has a driver and also two wedge segments. Depending on the embodiment of the driver and orientation thereof in relation to the wedge segments, which results in an eccentric arrangement or the gearwheel in relation to the longitudinal axis of the ring gear, an adjustment range of the driveshaft can be fixed, within which an adjustment does not result in a direct displacement of the first fitting part in relation to the second fitting part. The use of a driver in conjunction with two wedge segments is characterized here by the simple construction and also reliable function thereof.

In accordance with a particularly advantageous embodiment of the invention the wedge segments are pushed away from one another in the peripheral direction by a spring element, in particular an omega spring, in order to ensure a reliable bearing of the wedge segments in the bore of the gearwheel or in a sliding ring arranged within this bore. The use of an omega spring is particularly simple and economical, wherein this spring can be arranged on account of its design in a particularly space-saving manner in the seat fitting.

An exemplary embodiment of the invention will be explained in greater detail hereinafter with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded illustration of an embodiment of a seat fitting;

FIG. 2 is a schematic illustration of the embodiment of the assembled seat fitting illustrated in FIG. 1;

FIG. 3 is a perspective illustration of the ring gear, the stop cam carrier and the gearwheel of the embodiment of the seat fitting illustrated in FIG. 1; and

FIG. 4 is a perspective illustration of the ring gear of the embodiment of the seat fitting illustrated in FIG. 1 with the stop cam carrier arranged thereon.

### DESCRIPTION OF THE PREFERRED EMBODIMENTS

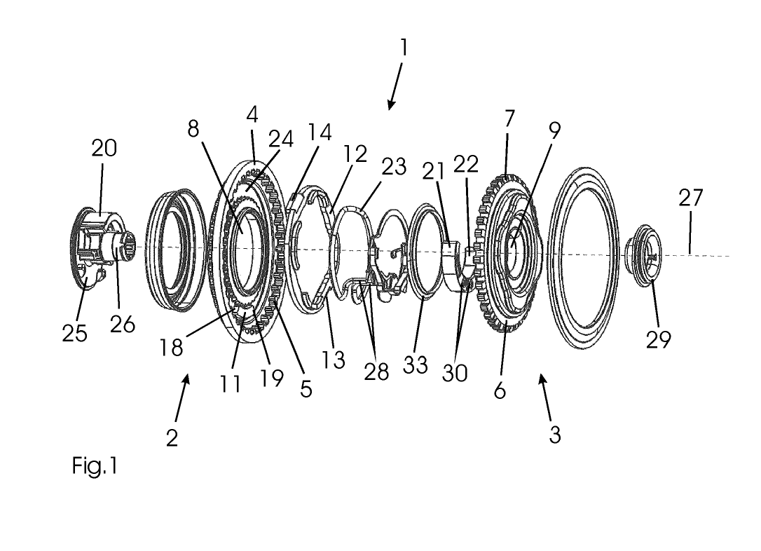

An embodiment of a vehicle seat fitting 1 illustrated in an exploded illustration in FIG. 1 has a first fitting part 2 and a second fitting part 3, which can be connected to a seat part (not illustrated here) and a backrest (likewise not illustrated) of a motor vehicle seat.

The vehicle seat fitting 1 has a ring gear 4 having an inner toothing 5. In the inner region 24 of the ring gear 4 between the inner toothing 5 and a bore 8 running axially with respect to the ring gear 4, the ring gear 4 has a blocking element 11, which extends coaxially with the bore 8 over an angular range of approximately 10° along the periphery of the ring gear 4. Here, the blocking element 11, which is formed in one piece with the ring gear 4, has two side faces 18, 19, which are oriented orthogonally to the surface of the ring gear 4 in the inner region 24 and normal to the peripheral direction of the inner toothing 5.

Furthermore, the vehicle seat fitting 1 has an externally toothed gearwheel 6 with a smaller number of teeth 7 than the ring gear 4, such that, when the gearwheel 6 is arranged eccentrically in relation to the ring gear 4, the gearwheel performs a wobble movement in relation to the first fitting part 2.

In order to achieve an eccentric arrangement of the gearwheel 6 in relation to the ring gear 4, the vehicle seat fitting 1 has an eccentric 10, which is formed from two wedge segments 21, 22 and also a driver 20 arranged on a driving wheel 25.

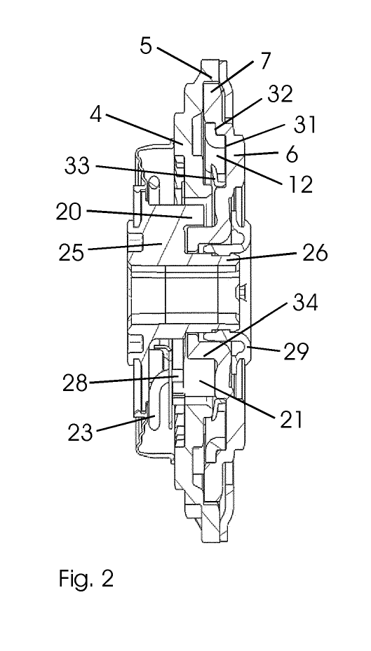

In the assembled state (FIG. 2) of the vehicle seat fitting 1, the wedge segments 21, 22 bear against a guide region 34 of the gearwheel 6. The driving wheel 25 extends with a stub shaft 26 along the fitting axis 27 running axially with respect to the ring gear 4, wherein the driver 20 arranged coaxially with the stub shaft 26 is arranged such that the end faces thereof can be brought into engagement with the end faces of the wedge segments 21, 22. The wedge segments 21, 22 are biased here away from one another in the peripheral direction by a spring element 23, which is arranged with the spring ends 28 thereof, which extend parallel to the fitting axis 27, in recesses 30 in the wedge segments 21, 22. In order to secure the position of the driving wheel 25, a securing ring 29 is used, which in the assembled state runs coaxially with the end of the stub shaft 26.

In the assembled state of the vehicle seat fitting 1, the centerpoint of the bore 9 in the gearwheel 6 is thus offset in relation to the fitting axis 27 running through the centerpoint of the bore 8 in the ring gear 4 by the off-center distance resulting from the difference of the pitch circles of the toothings 5, 7. The crescent-shaped gap thus formed is filled by the wedge segments 21, 22 arranged in a mirror image.

In the case in which the driving wheel 25 is driven via a hand wheel connected to the stub shaft 26 in a manner secure against rotation or via a drive driven by means of an electric motor, the driver 20 is displaced in the direction of the free ends of the wedge segments 21, 22 within the bore 8 of the ring gear 4. On account of the eccentricity, the gearwheel 6 rolls over a cycloid path within the ring gear 4 as the wedge segments 21, 22 are adjusted.

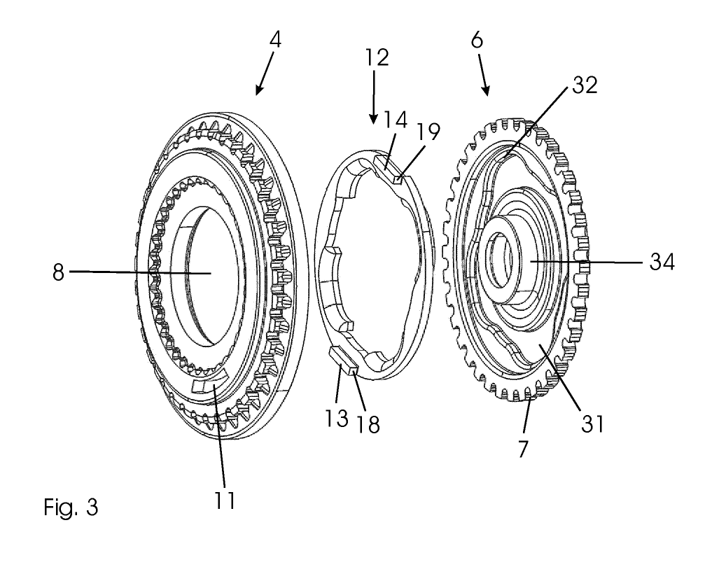

The vehicle seat fitting 1 also has a separate stop cam carrier 12 (FIG. 3) formed as a stop ring, which is provided with two stop cams 13, 14 arranged opposite one another on the stop cam carrier 12 with respect to the fitting axis 27.

In the installed state of the vehicle seat fitting 1, the stop cam carrier 12 is connected to the gearwheel 6 in a manner secure against rotation, such that the two stop cams 13, 14 are also fixed in relation to the gearwheel 6. For this purpose the gearwheel 6 has an indentation 31 with a “flower-like” outline 32, and the stop cam carrier 12 has an accordingly formed shaping, whereby a form fit exists in the peripheral direction.

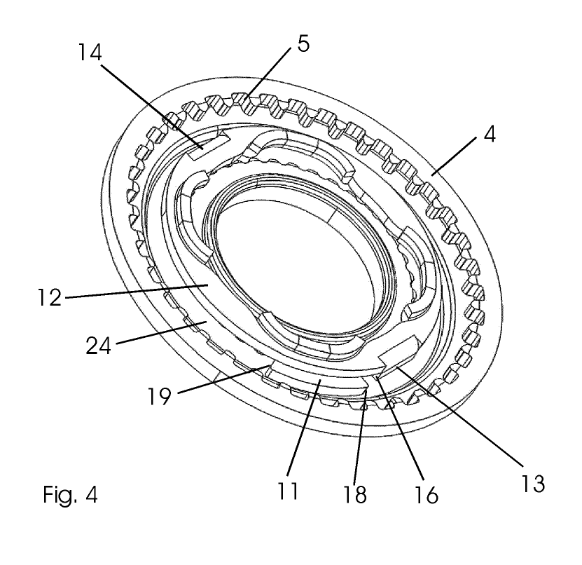

The stop cams 13, 14 protrude from the stop cam carrier 12 in the axial direction of the ring gear 4, wherein the stop cams 13, 14 in the installed state are arranged rotatably on the stop cam carrier 12 within the inner region 24 of the ring gear 4 (FIG. 4). The inner region 24 of the ring gear 4 is interrupted here by the blocking element 11 embossed through, of which the side faces 18, 19 each form a stop for a side face 16, 17 of the two stop cams 13, 14, whereby the adjustment movement of the ring gear 4 in relation to the gearwheel 6 is limited.

In order to secure the position of the stop cam carrier 12 in relation to the gearwheel 6, a spacer ring 33 that can be clipped in place is used, by means of which the stop cam carrier 12 is secure against axial and radial displacement.

The position of the stop cams 13, 14 on the stop cam carrier 12, in particular with respect to the periphery of the stop cam carrier 12, here determines the maximum possible pivot range of the vehicle seat fitting 1 and can be adapted in accordance with the manufacturer's specifications and in accordance with the requirements of the respective vehicle seat by use of a suitable stop cam carrier 12.

In order to prevent a jamming of the respective stop cam 13, 14 with the side faces 18, 19 of the blocking element 11, these are formed such that the stop cams 13, 14 are only then brought into contact via their side faces 16, 17 with one of the side faces 18, 19 of the blocking element 11 when the movement component of the path of the gearwheel 6 within the ring gear 4 directed in the peripheral direction is greater than the movement component directed in the radial direction.

While specific embodiments of the invention have been shown and described in detail to illustrate the application of the principles of the invention, it will be understood that the invention may be embodied otherwise without departing from such principles.

1. A seat fitting for a motor vehicle seat, the seat fitting comprising:
a first fitting part with a ring gear having an inner toothing;
a second fitting part with a gearwheel, which has an outer toothing and is meshed with the ring gear;
an eccentric mounted rotatably in a bore, running axially with respect to the gearwheel, in the second fitting part, and intended for a rolling adjustment of the gearwheel in relation to the ring gear;
a driveshaft, which drives the eccentric and extends axially with respect to the ring gear;
a blocking element on one of the gearwheel and the ring gear, the blocking element being arranged in a section running between the toothing and the bore; and
a stop cam carrier on the other of the gearwheel and the ring gear, the stop cam carrier being arranged in a manner secure against rotation, wherein the stop cam carrier comprises two stop cams, which cooperate with the blocking element such that a maximum adjustability of the two fitting parts with respect to one another in an opposed direction of movement is limited by one stop cam in each case.

2. The seat fitting as claimed in claim 1, wherein the blocking element has a profile coaxial with an associated bore and/or the stop cam has a profile coaxial with a centerpoint axis of the stop cam carrier.

3. The seat fitting as claimed in claim 1, wherein in an installed state the stop cams are arranged on the stop cam carrier such that the stop cams protrude substantially radially in a peripheral direction of the stop cam carrier on one side from the surface thereof and are arranged in a region of an outer periphery of the stop cam carrier.

4. The seat fitting as claimed in claim 1, wherein the stop cam carrier is formed in such a way and the ring gear or gearwheel have a corresponding embodiment, that the stop cam carrier in an installed state is fixed in relation to the gearwheel or ring gear in a form-fitting and/or force-locked manner.

5. The seat fitting as claimed in claim 1, wherein a side face of each of the stop cams, oriented in a peripheral direction and cooperating with the blocking element has a form adapted to a respective side face of the blocking element.

6. The seat fitting as claimed in claim 1, wherein the stop cams and the blocking element are positioned in such a way that each of the stop cams moved relative to the blocking element over a cycloid path during an adjustment comes into contact with a side face of the blocking element in a region of the path in which a movement component of the path, directed in a peripheral direction, is greater than a movement component directed in a radial direction.

7. The seat fitting as claimed in claim 1, wherein the gearwheel or the ring gear are formed in such a way that the stop cam carrier can be arranged between the two component parts with stop cams of any length in a peripheral direction and/or with stop cams arranged in any positions along the periphery.

8. The seat fitting as claimed in claim 1, wherein the blocking element is arranged on the ring gear, formed in one piece with the ring gear, and an extent of the blocking element in a peripheral direction of the ring gear is less than 25% of the periphery of the ring gear.

9. The seat fitting as claimed in claim 1, wherein the eccentric has a driver and also two wedge segments.

10. The seat fitting as claimed in claim 1, wherein the wedge segments are pushed away from one another in a peripheral direction by a spring element comprising an omega spring.
